(19) United States
(12) Patent Application Publication
(10) Pub. No.: US 2016/0034106 A1
(43) Pub. Date: Feb. 4, 2016

(54) TOUCH APPARATUS AND TOUCH SENSING METHOD THEREOF

(71) Applicants: Pen-Ning Kuo, Hsin-Chu (TW); Chung-Lung Yang, Hsin-Chu (TW); Yung-Chih Chen, Hsin-Chu (TW)

(72) Inventors: Pen-Ning Kuo, Hsin-Chu (TW); Chung-Lung Yang, Hsin-Chu (TW); Yung-Chih Chen, Hsin-Chu (TW)

(73) Assignee: Coretronic Corporation, Hsin-Chu (TW)

(21) Appl. No.: 14/583,195

(22) Filed: Dec. 26, 2014

(30) Foreign Application Priority Data
Jul. 29, 2014 (CN) 201410364505.6

(51) Int. Cl. G06F 3/042

(52) U.S. Cl. CPC G06F 3/0421

(57) ABSTRACT

A touch apparatus and a touch sensing method thereof are provided. Touch information generated according to received scanning beams is returned by a touch tool, and coordinates of the touch tool on a touch area is calculated according to the returned touch information.

### CROSS-REFERENCE TO RELATED APPLICATION

This application claims the priority benefit of China application serial no. 201410364505.6, filed on Jul. 29, 2014. The entirety of the above-mentioned patent application is hereby incorporated by reference herein and made a part of this specification.

### BACKGROUND OF THE INVENTION

1. Field of the Invention

The invention relates to an electronic device, and particularly relates to a touch apparatus and a touch sensing method thereof.

2. Description of Related Art

Generally speaking, the technology of optical touch control is implemented by disposing a light source and an optical sensor at the edge of a screen. The light source emits a light beam to scan a touch area, and the optical sensor is configured to sense a part of the light beam reflected by a touch tool (e.g., the user's finger or a touch pen). A touch position is then determined based on a sensing result of the optical sensor. Even though the conventional technology of optical touch control is already capable of effectively determining the touch position of a single touch point, the issues of blind area and ghost point arise when a multi-touch operation is performed by using a plurality of touch tools at the same time.

FIGS. 8A and 8B are schematic views illustrating a conventional touch apparatus. Referring to FIG. 8A, the conventional touch apparatus scans a touch area C1 by using scanning units 802 and 804 to emit scanning light beams. When the scanning light beam emitted by the scanning unit 802 contacts a touch tool 808 in the touch area C1, the touch tool 808 shields and reflects a part of the scanning light beam to form a blind area D. An optical sensor 806 is suitable for detecting the part of the scanning light beam reflected by the touch tool 808. At this time, if another touch tool 810 is located in the blind area D, since most of the scanning light beam is shielded by the touch tool 808, it is difficult for the optical sensor 806 to sense the scanning light beam reflected by the touch tool 810, making it unable to determine the position of the touch tool 810.

Referring to FIG. 8B, the optical sensor 806 is coupled to a control unit (not shown), the optical sensor 806 is suitable for detecting part of the scanning light beams reflected by the touch tools 808 and 810 and transmitting signals to the control unit. However, since the control unit obtains the positions of the touch tools 808 and 810 by calculating intersecting points of the scanning light beams, it is also possible that the control unit determines intersecting points 812 and 814 of the scanning light beams as the positions of the touch tools, which results in a misjudgment. The intersecting points 812 and 814 thus form the so-called ghost points. In addition, when the technology of optical touch control is applied to a large-sized screen such as an electronic whiteboard or a wall, it is usually time-consuming to dispose the scanning unit and the optical sensor. In addition, it also requires optical correction after the apparatus is set up. Therefore, the conventional technology still needs to be improved in terms of convenience.

Moreover, it is noted herein that patent documents relating to touch apparatuses include Taiwan Utility Patent No. M353418, Taiwan Patent No. I402722, Taiwan Patent Publication No. 201220138, and U.S. Patent Publication No. 20100170725 and U.S. Patent Publication No. 20110198134.

### SUMMARY OF THE INVENTION

The invention provides a touch apparatus and a touch sensing method thereof capable of effectively improving the issue of ghost point.

Other objects and advantages of the invention can be further understood by the technical features broadly embodied and described as follows.

To achieve one or a part of or all of the objects aforementioned or other objectives, an embodiment of the invention provides a touch apparatus, including a first scanning unit, a second scanning unit, a first control unit, and at least on touch tool. The first scanning unit emits a first scanning light beam to scan a touch area. The second scanning unit emits a second scanning light beam to scan the touch area. The first control unit is coupled to the first scanning unit and the second scanning unit, and controls the first and second scanning units to scan the touch area. The touch tool receives the first scanning light beam and the second scanning light beam to generate touch information when performing a touch operation in the touch area, and transmits the touch information to the first control unit wirelessly, wherein the touch information includes the time when the touch tool receives the first scanning light beam and the second scanning light beam, and the first control unit calculates coordinates of the touch tool in the touch area based on the touch information.

According to an embodiment of the invention, the first control unit broadcasts identification information of the first scanning unit when the first scanning unit scans the touch area and broadcasts identification information of the second scanning unit when the second scanning unit scans the touch area, wherein the touch information further includes the identification information of the first scanning unit corresponding to the first scanning light beam and the identification information of the second scanning unit corresponding to the second scanning light beam received by the touch tool.

According to an embodiment of the invention, the touch tool is a touch pen, and the touch tool includes a transparent tip, a receiving unit, a communication unit, and a second control unit. The receiving unit receives the first scanning light beam and the second scanning light beam through the transparent tip. The second control unit is coupled to the receiving unit and the communication unit, detects whether the receiving unit receives the first scanning light beam and the second scanning light beam, and sends the touch information to the first control unit through the communication unit when the receiving unit receives the first scanning light beam and the second scanning light beam.

According to an embodiment of the invention, the receiving unit is energized to receive the first scanning light beam and the second scanning light beam through the transparent tip when the transparent tip is pressed.

According to an embodiment of the invention, the receiving unit is a photodiode.

According to an embodiment of the invention, the first control unit further searches for the touch tool to wirelessly connect to and synchronize with the touch tool.

According to an embodiment of the invention, the first scanning unit, the second scanning unit, and the control unit are disposed on a long straight plate.

An embodiment of the invention provides a touch sensing method of a touch apparatus including steps as follows. A first scanning light beam is emitted to scan a touch area. A second scanning light beam is emitted to scan the touch area. Touch information is received from at least one touch tool, wherein the touch information includes the time when the touch tool receives the first scanning light beam and the second scanning light beam. Coordinates of the touch tool in the touch area are calculated based on the touch information.

According to an embodiment of the invention, the touch sensing method of the touch apparatus further includes steps as follows. Identification information of a first scanning unit corresponding to the first scanning light beam is broadcast when emitting the first scanning light beam. Identification information of a second scanning unit corresponding to the second scanning light beam is broadcast when emitting the second scanning light beam, wherein the touch information further includes the identification information of the first scanning unit corresponding to the first scanning light beam and the identification information of the second scanning unit corresponding to the second scanning light beam received by the touch tool.

According to an embodiment of the invention, the touch tool receives the first scanning light beam and the second scanning light beam when performing a touch operation in the touch area.

According to an embodiment of the invention, the touch tool is a touch pen having a transparent tip, and the touch pen receives the first scanning light beam and the second scanning light beam through the transparent tip when the transparent tip is pressed.

According to an embodiment of the invention, the touch sensing method of the touch apparatus further includes searching for the touch tool to wirelessly connect to and synchronize with the touch tool.

Based on the above, in the embodiments of the invention, the issue of ghost point is effectively solved by actively returning the touch information generated based on the touch light beam that is received through the touch tool, and calculating the coordinates of the touch tool in the touch area based on the returned touch information.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic view illustrating a touch apparatus according to an embodiment of the invention.

FIG. 2 is a schematic view illustrating a touch tool according to an embodiment of the invention.

FIGS. 3-5 are schematic views illustrating a touch apparatus according to an embodiment of the invention in use.

FIGS. 6-7 are schematic views illustrating touch sensing methods of a touch apparatus according to an embodiment of the invention.

FIGS. 8A and 8B are schematic views illustrating a conventional touch apparatus.

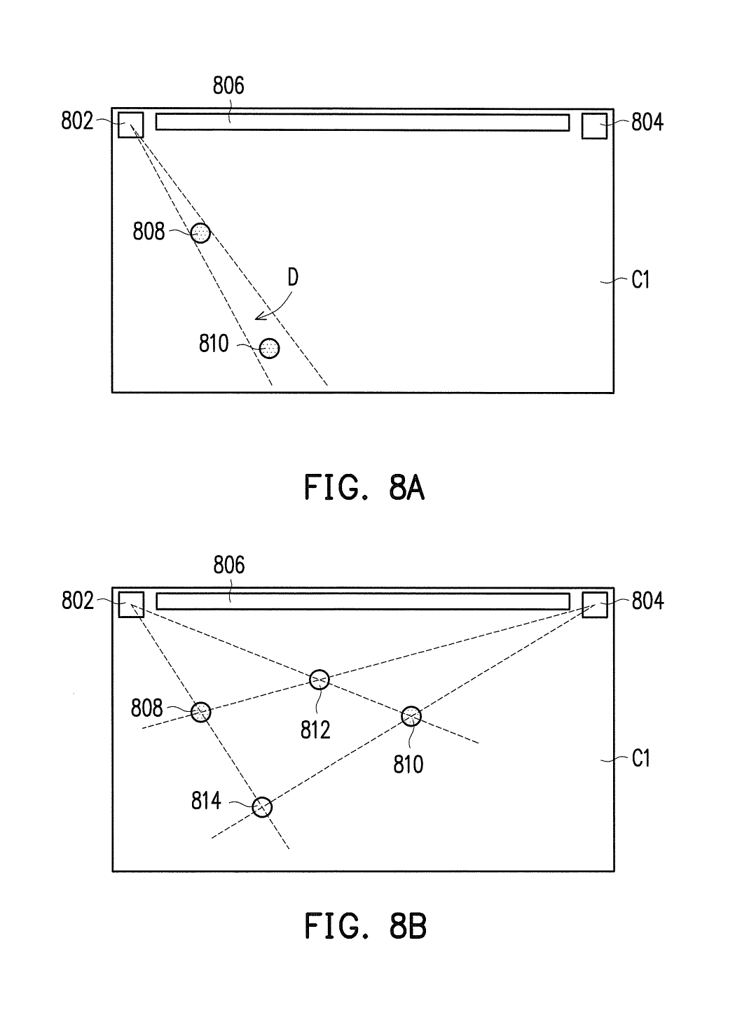

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

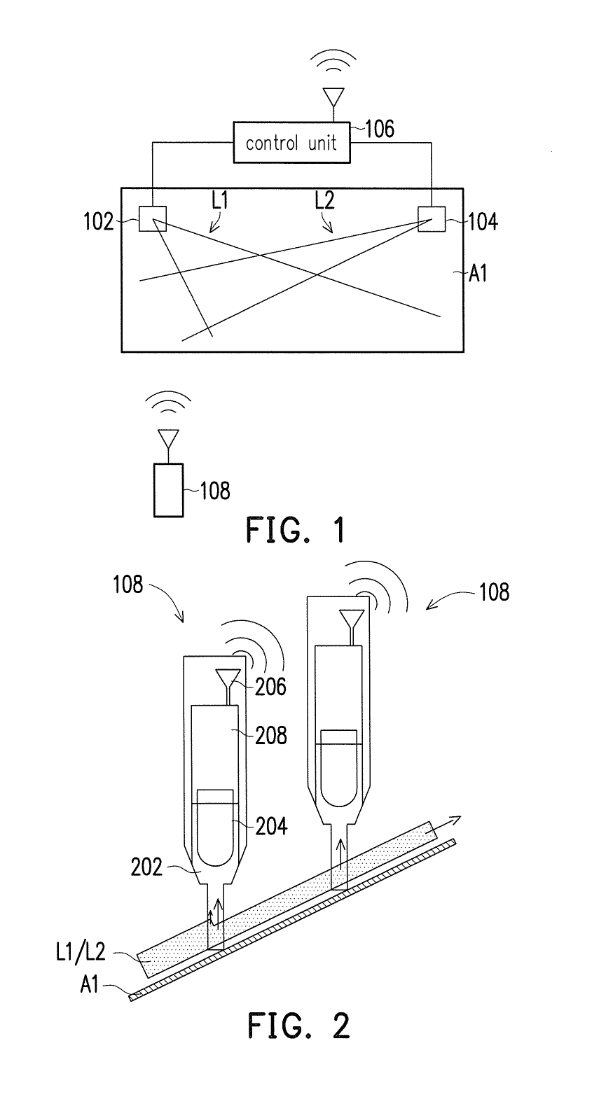

FIG. 1 is a schematic view illustrating a touch apparatus according to an embodiment of the invention. Referring to FIG. 1, the touch apparatus includes a scanning unit 102, a scanning unit 104, a control unit 106 and a touch tool 108. The control unit 106 is coupled to the scanning unit 102 and the scanning unit 104. The control unit 106 may respectively control the scanning unit 102 and the scanning unit 104 to emit a scanning light beam L1 and a scanning light beam L2 to scan a touch area A1. The touch area A1 serves to display an image. For example, the image may be displayed by projecting an image light beam to the touch area A1 using a projector. In addition, the control unit 106 may also search for the touch tool 108, so as to wirelessly connect to and synchronize with the touch tool 108. The touch tool 108 is a touch pen, for example. However, the invention is not limited thereto. The touch tool 108 may receive the scanning light beam L1 and the scanning light beam L2 respectively emitted by the scanning unit 102 and the scanning unit 104 when performing a touch operation in the touch area A1, generates touch information according to the time when the scanning light beam L1 and the scanning light beam L2 are received, and transmits the touch information to the control unit 106. The control unit 106 may control the scanning unit 102 and the scanning unit 104 to take turn to scan the touch area A1. In addition, rotating angles and rotating speeds of the scanning units 102 and 104 are fixed when scanning the touch area A1, and a distance between the scanning unit 102 and the scanning unit 104 is also fixed. Therefore, when receiving the touch information, the control unit 106 may calculate the rotating angles of the scanning units 102 and 104 when the touch tool 108 receives the scanning light beams L1 and L2, and calculate coordinate position of the touch tool 108 in the touch area A1 through a trigonometric function in combination with the distance between the scanning units 102 and 104. The scanning light beams L1 and L2 are infrared laser beams; however, the invention is not limited thereto. The scanning beams L1 and L2 may also be invisible light beams of other kinds as well.

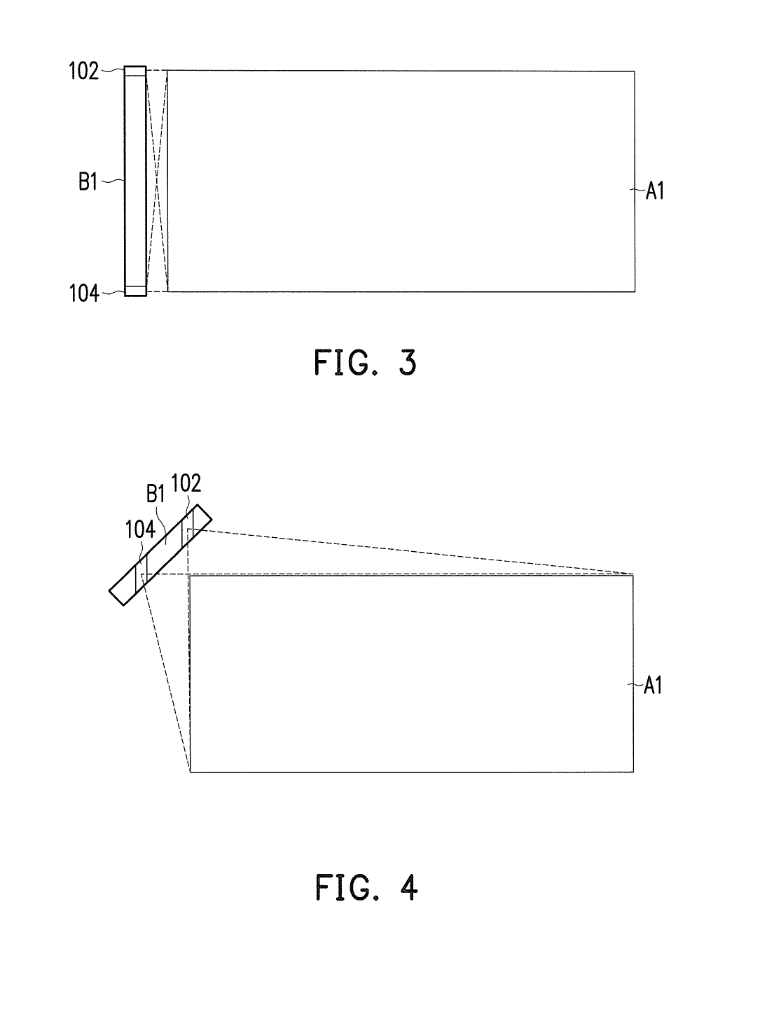

More specifically, as shown in FIG. 2, the touch tool 108 is a touch pen, for example, includes a transparent tip 202, a receiving unit 204, a communication unit 206, and a control unit 208. The control unit 208 is coupled with the receiving unit 204 and the communication unit 206. The receiving unit 204 is a photodiode, for example, receives the scanning light beams L1 and L2 through the transparent tip 202 and converts the scanning light beams L1 and L2 into electrical signals, thereby allowing the control unit 208 to be informed that the receiving unit 204 already receives the scanning light beams L1 and L2. Then the control unit 208 generates the touch information based on the time when the receiving unit 204 receives the scanning light beams L1 and L2, and transmits the touch information to the control unit 106 through the communication unit 206.

Since the receiving unit 204 receives the scanning light beams L1 and L2 through the transparent tip 202, only a part of the scanning light beam L1 and a part of the scanning light beam L2 are received by the receiving unit 204, and the remaining scanning light beams L1 and L2 pass through the transparent tip 202 and are transmitted along the original direction. In this way, even if there are plural touch tools 108 performing touch operations at the same time on a light path of the same scanning light beam, the touch tools 108 are still able to receive the scanning light beam respectively (in FIG. 2, two touch tools 108 are shown as an example). In this way, a blind area for touch control in the touch area A1 may be prevented, and the issue of ghost points when a conventional touch apparatus performs a multi-touch operation may be solved effectively.

It should be noted that the receiving unit 204 in the touch tool 108 may be designed to be energized when the transparent tip 202 is pressed. For example, it may be designed that the receiving unit 204 is electrically connected to the control unit 208 when the transparent tip 202 is pressed, and the receiving unit 204 thus receives and converts the scanning light beams L1 and L2 into electrical signals to the control unit 208. Such configuration ensures that the touch tool 108 only receives the scanning light beam when performing a touch operation, and prevents the transparent tip 202 from receiving the scanning light beam before actually touching a plane of the touch area A1, resulting in a misjudgment of touch position.

In addition, in other embodiments, when the control unit 106 controls the scanning units 102 and 104 to emit the scanning light beams L1 and L2 to scan the touch area A1, the control unit 106 may also broadcast identification information of the scanning units 102 and 104 to inform the touch tool 108 where the received scanning light beam is emitted from. Also, the touch information generated by the touch tool 108 may also include the identification information of the scanning unit corresponding to the emitted scanning light beam in addition to the time when the scanning light beam is received. In this way, the control unit 106 is able to more accurately verify the time when the touch tool 108 receives each scanning light beam and the corresponding identification information of the scanning unit, so as to further avoid misjudgment of touch position.

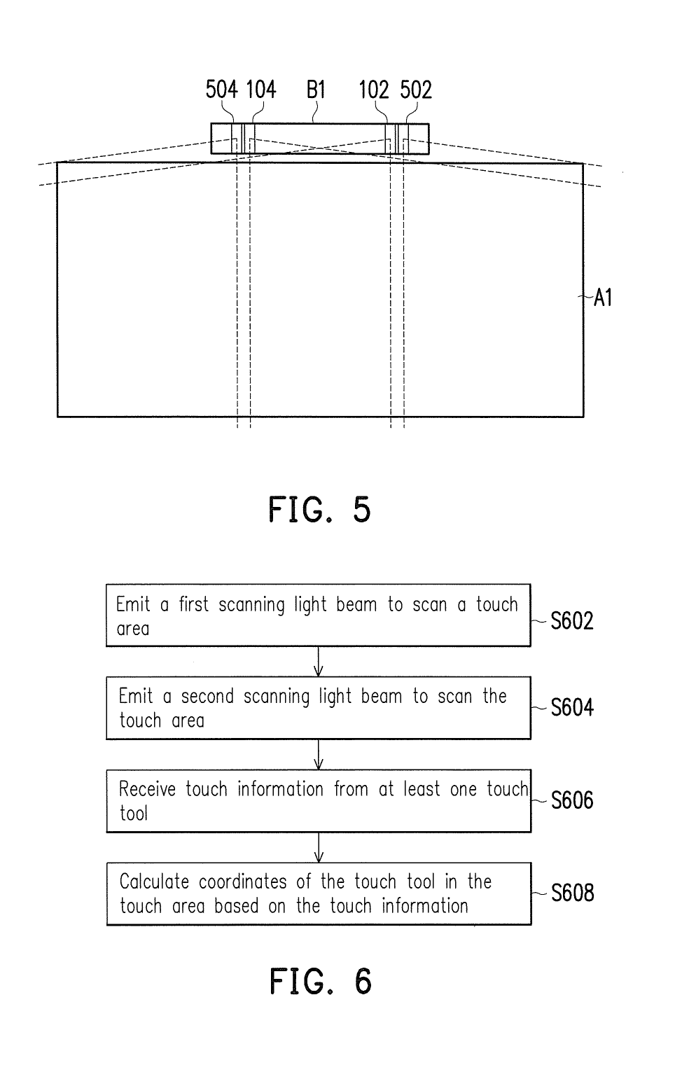

FIGS. 3-5 are schematic views illustrating a touch apparatus according to an embodiment of the invention in use. In FIGS. 3 to 5, the scanning units 102 and 104 of the touch apparatus and the control unit 106 receiving the touch information are all disposed on a long straight plate B1. For the conciseness of drawings, the control unit 106 is not shown in FIGS. 3-5. Since the distance between the scanning units 102 and 104 on the long straight plate B1 is fixed, no matter how the long straight plate B1 is arranged, the control unit is still able to calculate the touch position of the touch tool 108 based on the touch information and the distance between the scanning units 102 and 104. For example, the long straight plate B1 shown in FIGS. 3 and 5 is located at one side of the touch area A1, and the long straight plate B1 shown in FIG. 4 is located at a corner of the touch area A1. By fixing the scanning units 102 and 104 on the long straight plate B1, it only requires to dispose the long straight plate B1 on a plane that the touch area A1 is located at when installing the touch apparatus. Therefore, the significant amount of time and cost of labor consumed for installing the apparatus as in the conventional technology may be saved.

In addition, positions where the scanning units 102 and 104 are fixed on the long straight plate B1 may be designed based on the actual practice, as long as scanning ranges of the scanning units 102 and 104 cover the touch area A1. Such configuration ensures that a touch operation may be performed at every position in the touch area A1. In some embodiments, if the touch area A1 is too large, the number of scanning units may be increased to supplement the scanning ranges (as indicated by dotted lines of FIGS. 3-5) of the scanning light beams. For example, in the embodiment shown in FIG. 5, since the scanning ranges of the scanning units 102 and 104 are limited and insufficient to cover the touch area A1, scanning units 502 and 504 are additionally disposed on the long straight plate B1, such that every position in the touch area A1 at least falls within the scanning ranges of two scanning units. Functions and connecting relations of the scanning units 502 and 504 are similar to those of the scanning units 102 and 104. Therefore, people skilled in the art may refer to the embodiments above for details regarding operations of the scanning units 502 and 504, and no further details in this respect will be reiterated hereinafter.

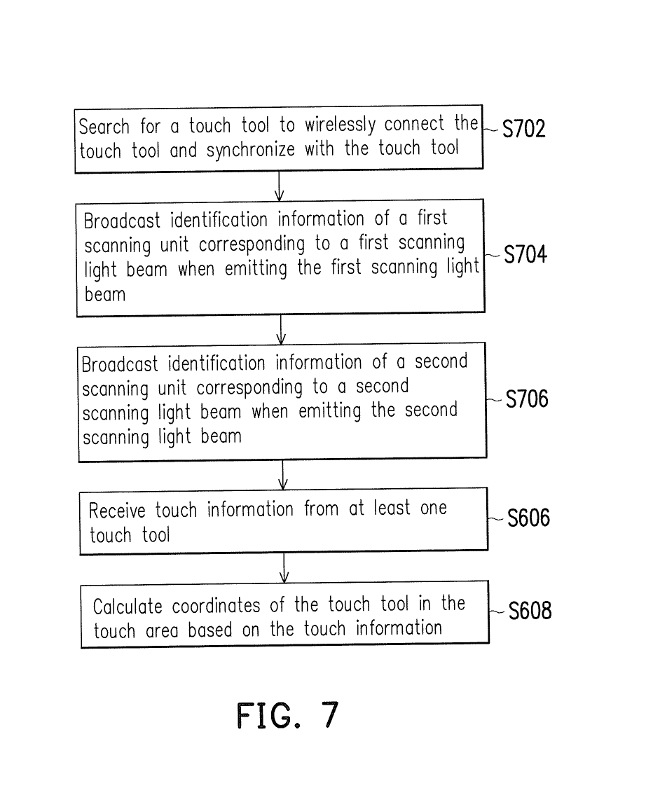

FIG. 6 is schematic view illustrating a touch sensing method of a touch apparatus according to an embodiment of the invention. Referring to FIG. 6, the touch sensing method of the touch apparatus includes steps as follows. First of all, a first scanning light beam is emitted to scan a touch area (Step S602). Then, a second scanning light beam is emitted to scan the touch area (Step S604). Then, touch information from at least one touch tool is received (Step S606). The touch tool may be a touch pen having a transparent tip, for example. The touch pen receives a first scanning light beam and a second scanning light beam through the transparent tip when the transparent tip is pressed. In other words, the first scanning light beam and the second scanning light beam are received when the touch tool performs a touch operation in the touch area, and the touch information includes the time when the first scanning light beam and the second scanning light beam are received. Lastly, coordinates of the touch tool in the touch area is calculated based on the touch information (Step S608).

FIG. 7 is schematic views illustrating a touch sensing method of a touch apparatus according to an embodiment of the invention. Referring to FIG. 7, in this embodiment, before performing a touch operation, a touch tool is searched for wirelessly connect to and synchronize with the touch tool (Step S702). Then, identification information of a first scanning unit corresponding to a first scanning light beam is broadcast when the first scanning light beam is emitted (Step S704). Then, identification information of a second scanning unit corresponding to a second scanning light beam is broadcast when the second scanning light beam is emitted (Step S706). Then, Step S606 is performed to receive touch information from at least one touch tool, and then coordinates of the touch tool in the touch area are calculated based on the touch information (Step S608). It should be noted that in this embodiment, the touch information further includes the identification information of the first scanning unit corresponding to the first light beam and the identification information of the second scanning unit corresponding to the second scanning light beam in addition to the time when the scanning light beams are received.

In view of the foregoing, in the embodiments of the invention, the issue of ghost point is effectively solved to prevent the blind area for touch control in the touch area by designing the touch tool to actively return the touch information generated based on the touch light beam that is received, and calculating the coordinates of the touch tool in the touch area based on the returned touch information. In some embodiments, the scanning unit is fixed on the long straight plate to save the time and cost of labor consumed for installing the touch apparatus in the conventional art.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. And these claims may refer to use “first,” “second,” etc. following with noun or element. Such terms should be understood as a nomenclature and should not be construed as giving the limitation on the number of the elements modified by such nomenclature unless specific number has been given.

What is claimed is:

1. A touch apparatus, comprising a first scanning unit, a second scanning unit, a first control unit, and at least one touch tool, wherein:
the first scanning unit emits a first scanning light beam to scan a touch area,
the second scanning unit emits a second scanning light beam to scan the touch area,
the first control unit is coupled to the first scanning unit and the second scanning unit, and controls the first and second scanning units to scan the touch area, and
the at least one touch tool receives the first scanning light beam and the second scanning light beam to generate touch information when performing a touch operation in the touch area, and transmits the touch information to the first control unit wirelessly, wherein the touch information comprises the time when the touch tool receives the first scanning light beam and the second scanning light beam, and the first control unit calculates coordinates of the touch tool in the touch area based on the touch information.

2. The touch apparatus as claimed in claim 1, wherein the first control unit broadcasts identification information of the first scanning unit when the first scanning unit scans the touch area and broadcasts identification information of the second scanning unit when the second scanning unit scans the touch area, and the touch information further comprises the identification information of the first scanning unit corresponding to the first scanning light beam and the identification information of the second scanning unit corresponding to the second scanning light beam received by the at least one touch tool.

3. The touch apparatus as claimed in claim 1, wherein the touch tool is a touch pen, and the touch tool comprises a transparent tip, a receiving unit, a communication unit, and a second control unit,
the receiving unit receives the first scanning light beam and the second scanning light beam through the transparent tip, and
the second control unit is coupled to the receiving unit and the communication unit, detects whether the receiving unit receives the first scanning light beam and the second scanning light beam, and sends the touch information to the first control unit through the communication unit when the receiving unit receives the first scanning light beam and the second scanning light beam.

4. The touch apparatus as claimed in claim 3, wherein the receiving unit is energized to receive the first scanning light beam and the second scanning light beam through the transparent tip when the transparent tip is pressed.

5. The touch apparatus as claimed in claim 3, wherein the receiving unit is a photodiode.

6. The touch apparatus as claimed in claim 1, wherein the first control unit further searches for the touch tool to wirelessly connect to and synchronize with the touch tool.

7. The touch apparatus as claimed in claim 1, wherein the first scanning unit, the second scanning unit, and the control unit are disposed on a long straight plate.

8. A touch sensing method of a touch apparatus, comprising:
emitting a first scanning light beam to scan a touch area;
emitting a second scanning light beam to scan the touch area;
receiving touch information from at least one touch tool, wherein the touch information comprises the time when the touch tool receives the first scanning light beam and the second scanning light beam; and
calculating coordinates of the touch tool in the touch area based on the touch information.

9. The touch sensing method of the touch apparatus as claimed in claim 8, further comprising:
broadcasting identification information of a first scanning unit corresponding to the first scanning light beam when emitting the first scanning light beam; and
broadcasting identification information of a second scanning unit corresponding to the second scanning light beam when emitting the second scanning light beam, wherein the touch information further comprises the identification information of the first scanning unit corresponding to the first scanning light beam and the identification information of the second scanning unit corresponding to the second scanning light beam received by the at least one touch tool.

10. The touch sensing method of the touch apparatus as claimed in claim 8, wherein the touch tool receives the first scanning light beam and the second scanning light beam when performing a touch operation in the touch area.

11. The touch sensing method of the touch apparatus as claimed in claim 8, wherein the touch tool is a touch pen having a transparent tip, and the touch pen receives the first scanning light beam and the second scanning light beam through the transparent tip when the transparent tip is pressed.

12. The touch sensing method of the touch apparatus as claimed in claim 8, further comprising:
searching for the touch tool to wirelessly connect to and synchronize with the touch tool.
